(19) United States
(12) Patent Application Publication
(10) Pub. No.: US 2014/0052516 A1
(43) Pub. Date: Feb. 20, 2014

(54) Method and Apparatus for Combining Referral Rates in a Referral System

(71) Applicant: George Cox Beighley, JR., Columbia, SC (US)

(72) Inventor: George Cox Beighley, JR., Columbia, SC (US)

(21) Appl. No.: 13/962,097

(22) Filed: Aug. 8, 2013

Related U.S. Application Data
(60) Provisional application No. 61/703,030, filed on Sep. 19, 2012.
(60) Provisional application No. 61/683,961, filed on Aug. 16, 2012.
(60) Provisional application No. 61/693,448, filed on Aug. 27, 2012.

(51) Int. Cl. G06Q 30/02

(52) U.S. Cl. CPC G06Q 30/0214
USPC 705/14.16

(57) ABSTRACT

In some embodiments, for resellers of goods, multiple referral rates can be combined to yield a greater total referral rate. For example, the manufacturer can offer one referral rate and the reseller can offer a second referral rate. The central depository combines the two referral rates to have a greater total referral rate, which is paid to the referring user. The central depository also displays the combined referral rate in a list for the referring user. Upon activation, the central depository collects payment from all parties offering a referral rate in this example the manufacture and the reseller. The central depository can collect payment separately for each party (the manufacture and the reseller). In an alternative embodiment, the central depository collects payment from one party for both referral rates. In this embodiment the party who pays the combine referral rate collects payment from the other party.

### PRIORITY CLAIM

This application claims priority under 35 U.S.C. §119(e) from U.S. Provisional Patent Application Ser. Nos. 61/703,030 entitled “Combining Referral Rates” filed Sep. 19, 2012; 61/683,961 entitled “System and Method for Hyperlink Conversion” filed Aug. 16, 2012; and 61/693,448 entitled “System and Method for a Hyperlink Discount Process without Referred User Identity” filed Aug. 27, 2012, which are hereby incorporated by reference in their entireties.

This application incorporates by reference U.S. Non-Provisional patent application Ser. No. 13/551,983 entitled “Central Depository Processing of Referral Hyperlinks and Advertisements” filed Jul. 18, 2012, which is hereby incorporated by reference in its entirety. U.S. Non-Provisional patent application Ser. No. 13/551,984 claimed the priority benefit of U.S. Provisional Application Nos. 61/508,880, entitled “Method and Apparatus for Computer-Based Processing of Referral and Discount Programs” filed Jul. 18, 2011; 61/573,064 entitled “Apparatus and Method for Computer-Based Referral and Discount Programs” filed Aug. 23, 2011; 61/555,628 entitled “Method and Apparatus for Referring Goods, Services, and Intellectual Property” filed Nov. 4, 2011; and 61/589,521 entitled “Electronic Referral System and Methods” filed Jan. 23, 2012.

This application incorporates by reference U.S. Non-Provisional patent application Ser. No. 13/552,011 entitled, “Merchant Processing of Referral Hyperlinks and Advertisements” filed Jul. 18, 2012, which is hereby incorporated by reference in its entirety. U.S. Non-Provisional patent application Ser. No. 13/552,011 claimed the priority benefit of U.S. Provisional Application Nos. 61/508,880, entitled “Method and Apparatus for Computer-Based Processing of Referral and Discount Programs” filed Jul. 18, 2011; 61/573,064 entitled “Apparatus and Method for Computer-Based Referral and Discount Programs” filed Aug. 23, 2011; 61/555,628 entitled “Method and Apparatus for Referring Goods, Services, and Intellectual Property” filed Nov. 4, 2011; and 61/589,521 entitled “Electronic Referral System and Methods” filed Jan. 23, 2012.

This application incorporates by reference U.S. Non-Provisional patent application Ser. No. 13/552,031 entitled “Processing of Electronic Referral Hyperlinks” filed on Jul. 18, 2012, which is hereby incorporated by reference in its entirety. U.S. Non-Provisional patent application Ser. No. 13/552,031 claims the priority benefit of Provisional Application Nos. 61/508,880, entitled “Method and Apparatus for Computer-Based Processing of Referral and Discount Programs” filed Jul. 18, 2011; 61/573,064 entitled “Apparatus and Method for Computer-Based Referral and Discount Programs” filed Aug. 23, 2011; 61/555,628 entitled “Method and Apparatus for Referring Goods, Services, and Intellectual Property” filed Nov. 4, 2011; and 61/589,521 entitled “Electronic Referral System and Methods” filed Jan. 23, 2012, which are hereby incorporated by reference in their entireties.

### BACKGROUND

The present invention relates to further developments of the technology of referral hyperlinks using a central depository and/or merchant methods. The background generally relates to a software process in the fields of banking, internet functionality, as applied to a social media or search engine markets.

### SUMMARY

In some embodiments, for resellers of goods, multiple referral rates can be combined to yield a greater total referral rate. For example, the manufacturer can offer one referral rate and the reseller can offer a second referral rate. The central depository combines the two referral rates to have a greater total referral rate, which is paid to the referring user. The central depository also displays the combined referral rate in a list for the referring user. Upon activation, the central depository collects payment from all parties offering a referral rate in this example the manufacture and the reseller. The central depository can collect payment separately for each party (the manufacture and the reseller). In an alternative embodiment, the central depository collects payment from one party for both referral rates. In this embodiment the party who pays the combine referral rate collects payment from the other party. Further, discounts by a manufacturer and a reseller are also combined to yield a greater total discount.

In some embodiments, a crawl program or other automated program, which acquires links to various merchants from the merchant's webpage automatically, converts hyperlinks to those web pages into referral links to those web pages routed through the central depository opposed directly to the merchant. In an alternative, embodiment automated programs convert merchant web pages into referral links directly to the merchant. In this way the referred user can keep track of the discounts. In some embodiments, a first referring site shares referral information with a second referring site, which adds the second referring sites information to the referral link

In some embodiments, the process involves performing similar functions articulated by the referral and discount process contained in U.S. patent application Ser. Nos. 13/551,983, 13/552,011, and 13/552,031 only without the user creating an account. Rather, the central depository stores the discounts with the internet protocol address, (hereinafter “i.p. address” or “ip address”) of the referred user and transfers the referred user to the merchant with an i.p. address opposed to a referred user identity. In an additional embodiment, the merchant stores the discount with the i.p. address of the referred user without storing the discount with a referred account that the referred user creates.

### BRIEF DESCRIPTION OF DRAWINGS

The following will be apparent form elements of the figure, which are provided for illustrative purposes and are not necessarily to scale.

FIG. 1A is a block diagram of an electronic referral system in accordance with some embodiments of the present disclosure related to the combining of referral rates and combining of discount rates.

FIG. 1B is a block diagram of an electronic referral system in accordance with some embodiments of the present disclosure related to the combining of referral rates and combining of discount rates.

FIG. 1C is a block diagram of an electronic referral system in accordance with some embodiments of the present disclosure related to the combining of referral rates and combining of discount rates.

FIG. 1D is a block diagram of an electronic referral system in accordance with some embodiments of the present disclosure related to the combining of referral rates and combining of discount rates.

FIG. 1E is a block diagram of an electronic referral system in accordance with some embodiments of the present disclosure related to the combining of referral rates and combining of discount rates.

FIG. 1F is a block diagram of an electronic referral system in accordance with some embodiments of the present disclosure related to the combining of referral rates and combining of discount rates.

FIG. 1G is a block diagram of an electronic referral system in accordance with some embodiments of the present disclosure related to the combining of referral rates and combining of discount rates.

FIG. 1H is a block diagram of an electronic referral system in accordance with some embodiments of the present disclosure related to the combining of referral rates and combining of discount rates.

FIG. 2 is a sequence diagram showing interactions between merchants, central depository, and users in the combining of referral rates and the combining of discount rates.

FIG. 3 is a sequence diagram showing interactions between merchants and users in the combining of referral rates and the combining of discount rates.

FIG. 4A is a block diagram showing a computer system in accordance with some embodiments of the present disclosure related to the conversion of hyperlinks

FIG. 4B is a block diagram showing a computer system in accordance with some embodiments of the present disclosure related to the conversion of hyperlinks

FIG. 4C is a block diagram showing a computer system in accordance with some embodiments of the present disclosure related to the conversion of hyperlinks

FIG. 4D is a block diagram showing a computer system in accordance with some embodiments of the present disclosure related to the conversion of hyperlinks

FIG. 4E is a block diagram showing a computer system in accordance with some embodiments of the present disclosure related to the conversion of hyperlinks

FIG. 5 is a sequence diagram showing the interactions between users, merchant, and central depository in the conversion of hyperlinks

FIG. 6A is a block diagram of an electronic referral system in accordance with some embodiments of the present disclosure related to the anonymous referred user discount process.

FIG. 6B is a block diagram of an electronic referral system in accordance with some embodiments of the present disclosure related to the anonymous referred user discount process.

FIG. 6C is a block diagram of an electronic referral system in accordance with some embodiments of the present disclosure related to the anonymous referred user discount process.

FIG. 6D is a block diagram of an electronic referral system in accordance with some embodiments of the present disclosure related to the anonymous referred user discount process.

FIG. 6E is a block diagram of an electronic referral system in accordance with some embodiments of the present disclosure related to the anonymous referred user discount process.

FIG. 7 is a sequence diagram showing the interactions between users, merchant, and central depository in the anonymous referred user discount process.

FIG. 8 is a sequence diagram showing the interactions between users, and merchant in the anonymous referred user discount process

### DETAILED DESCRIPTION

### Combining Referral Rates: Central Depository Embodiment

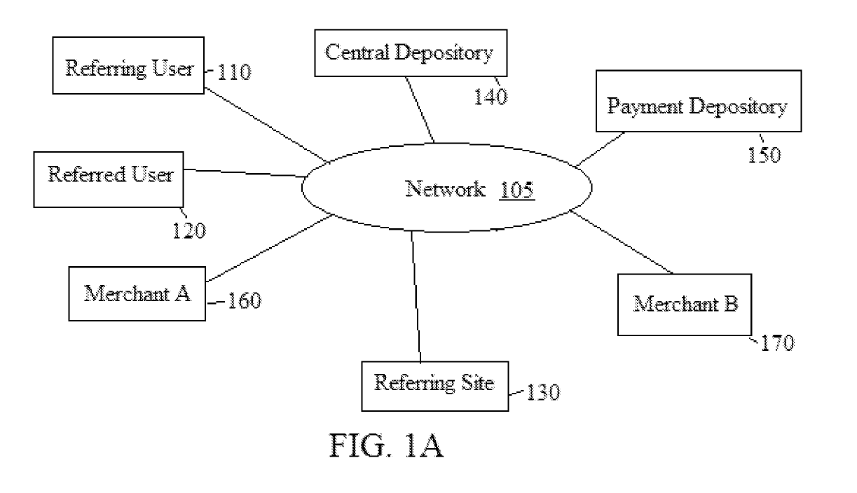

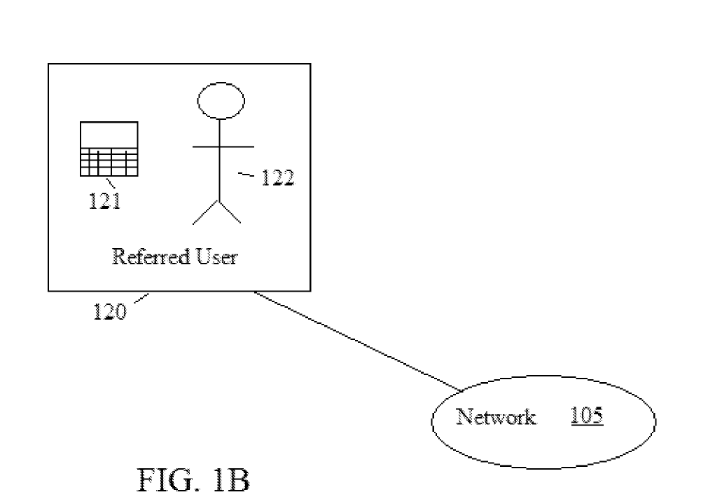

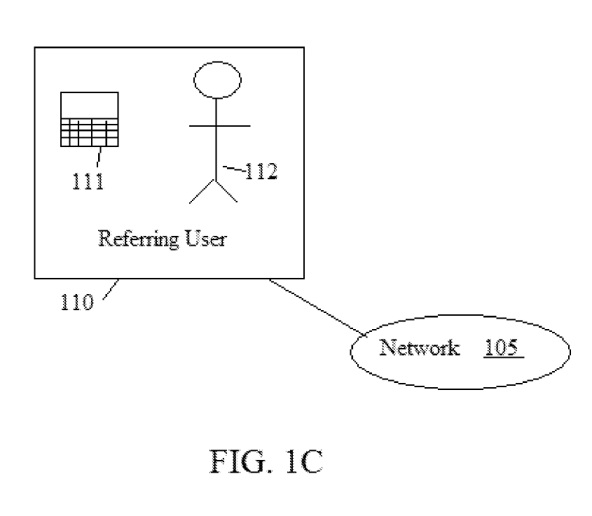

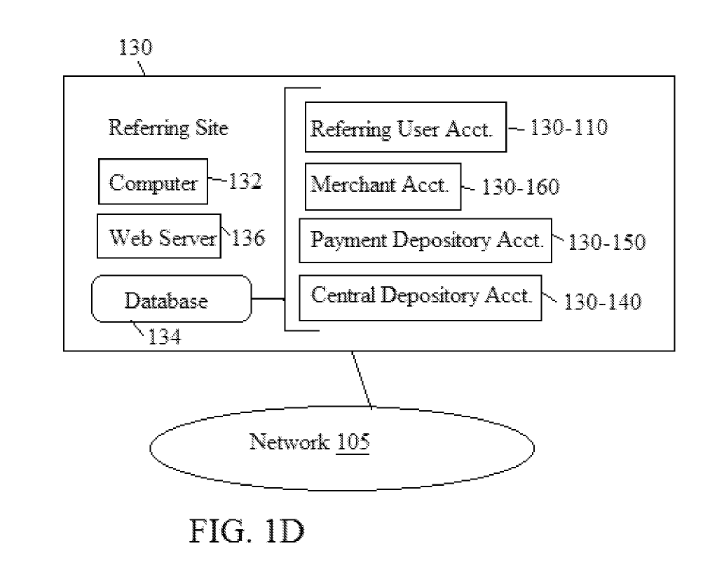

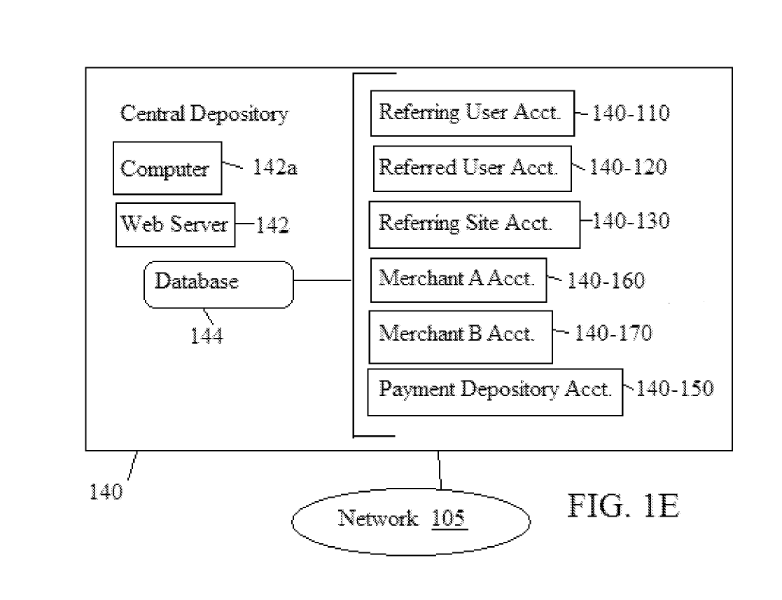

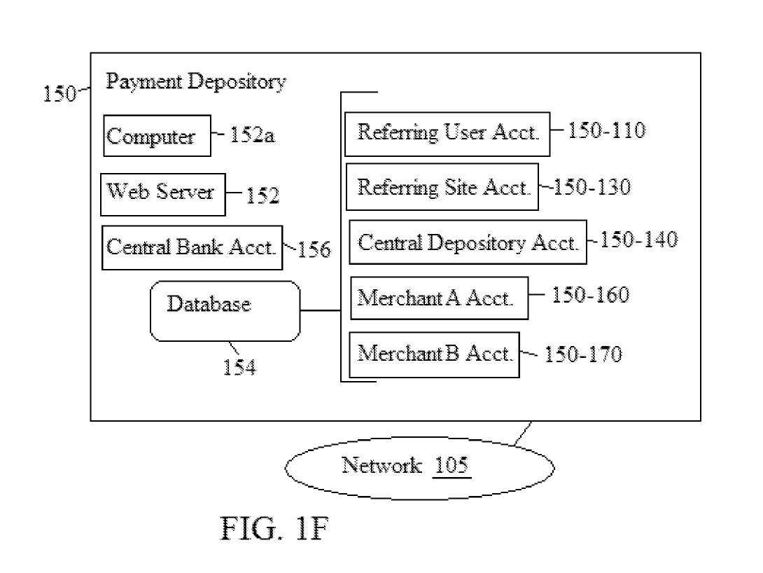

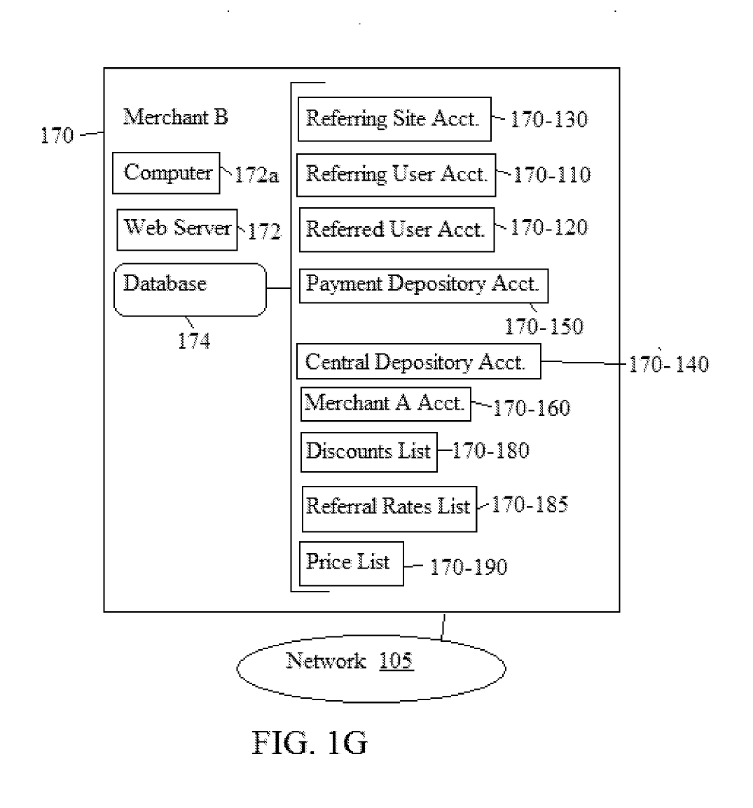

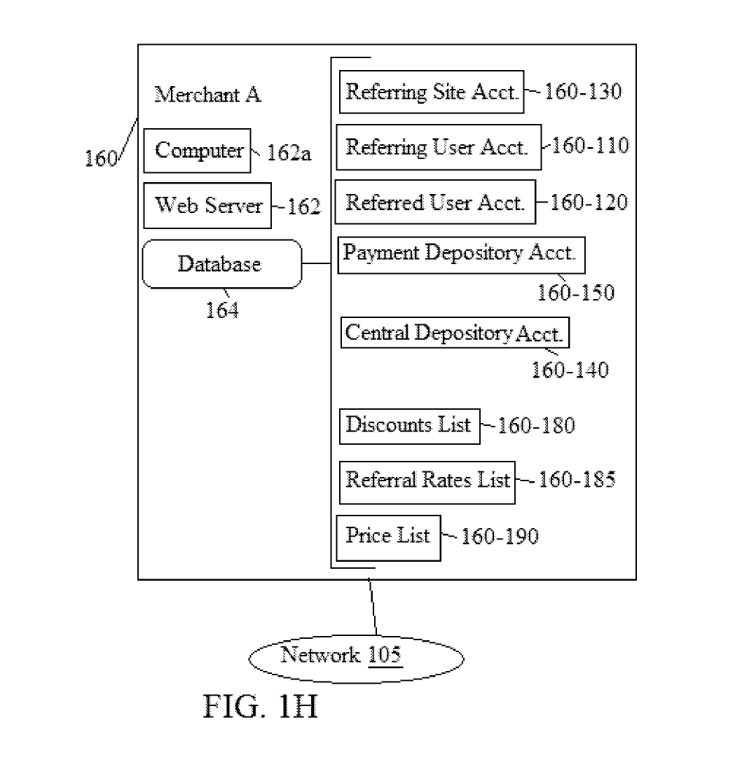

As shown in FIG. 1A, the system involved in the combination of referral rates consists of a central depository 140, a referring user 110, a referred user 120, a referring site 130, Merchant A System 160, merchant B system 170, a payment depository 150, and a network 105.

As shown in FIG. 1B, the referred user 120 consists of an individual user 122 using a computer 121 with access to the network 105.

As shown in FIG. 1C, the referring user 110 consists of an individual user 112 using a computer 111 with access to the network 105.

As shown in FIG. 1D, the referring site 130 system consists of a computer 132, a web server 136, a database 134 consisting of a referring user account 130-110 a merchant account 130-160 a payment depository account 130-150, a central depository account 130-140 connected to the network 105.

As shown in FIG. 1E, the central depository system 140 consists of a web server 142, a computer 142a, a database 144, which consists of a referring user account 140-110, a referred user account 140-120, a referring site account 140-130, a merchant A account 140-160, a merchant B account 140-170, a payment depository account 140-150 all of which are connected to a network 105.

As shown in FIG. 1F, the payment depository' system 150 consists of a computer 152a, a web server 152, a central bank account 156 with bank accounts for the referring user 110, and optionally the merchant A 160, and merchant B 170, a database 154 with accounts for the referring user 150-110, the referring site 150-130, the central depository account 150-140, the merchant A account 150-160, and the merchant B account 150-170 connected to the network 105.

As shown in FIG. 1G, the merchant B system 170 consists of a web server 172, a computer 172a, a database 174 with referring site account 170-130, referring user account 170-110, a referred user account 170-120, a payment depository account 170-150, a central depository account 170-140, a merchant A account 170-160, a discounts list 170-180, a referral rates list 170-185, and a price list 170-190 connected to the network 105.

As shown in FIG. 1H, the merchant A system 160 consists of a web server 162, a computer 162a, a database 164 with referring site account 160-130, referring user account 160-110, a referred user account 160-120, a payment depository account 160-150, a central depository account 160-140, a discounts list 160-180, a referral rates list 160-185, and a price list 160-190 connected to the network 105.

A central depository 140 receives from a Merchant A 160 a referral rate payable to a referring user 110 for referring a specific product or business, a discount rate payable to a referred user 120 for selecting the product, and stores this referral rate and discount with the merchant A's account 140-160. A central depository 140 receives from merchant B 170 an additional referral rate and discount rate for the same product or business. Two or more merchants' referral rates may be combined to generate a total collective referral rate. The central depository 140 combines the two referral rates and stores the combined referral rate with the merchant B's account 140-170. Two or more merchants' discount rates may be combined to generate a total collective discount rate. The central depository 140 combines the two discount rates and stores the combined discount rate with merchant B's account 140-170. The central depository 140 stores the referral rates and discount rates on a database 144 connected to the central depository's system 140. The central depository 140 displays the collective referral rates and discount rates to referring users 110 accessing the central depository's website.

A referring user 110 activates a link with instructions to create a referral hyperlink for the product for the specific referring user. The central depository 140 creates a referral hyperlink with the combined referral rate and discount rate as articulated in U.S. patent application Ser. Nos. 13/551,983, 13/552,011, and 13/552,031 and sends it to the referring user 110. The referring user 110 posts the referral hyperlink A referred user 120 activates the referral hyperlink posted by the referring user. The referred user 120 receives the combined discount rate. The central depository 140 processes the request and demands payment from a merchant A 160 and the other merchant or merchants (merchant B) 170, which offered a referral rate for the product. The central depository 140 pays the referring user 110 the collective referral rate. In an alternative embodiment, the central depository 140 contacts a payment depository 150 to direct payment to the referring user, as articulated in U.S. patent application Ser. Nos. 13/551,983, 13/552,011, and 13/552,031. The central depository 140 sends the combined discount rater to Merchant B 170. Merchant B 170 applies the discount rate to the referred users 120 purchase.

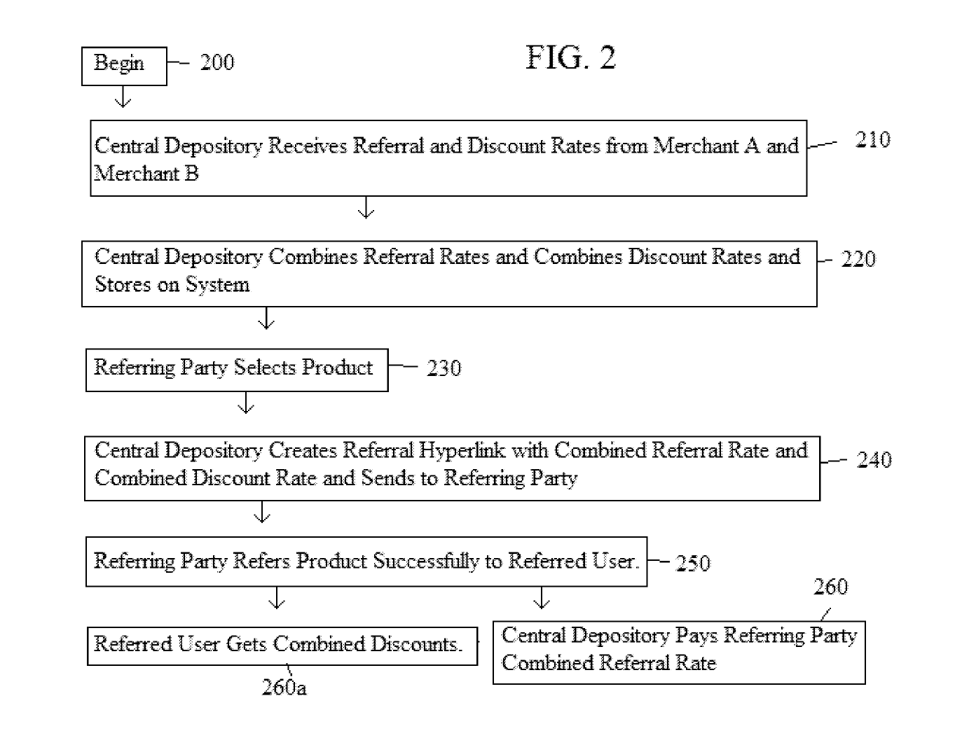

As shown in FIG. 2, the central depository receives the referral rate and discount rate from Merchant A and Merchant B 210. The central depository combines the referral rates and combines the discount rates and stores on the central depository's system 220. The referring user selects the product which has a combined referral rate and the combined discount rate 230. Using methods articulated in U.S. patent application Ser. Nos. 13/551,983, 13/552,011, and 13/552,031, the central depository creates a referral hyperlink with the combined referral rates and combined discount rates for the referring party and sends to the referring party 240. The referring party successfully refers the product to the referred user 250. The central depository pays the referring party the combined referral rate 260 or alternatively, the central depository instructs the merchants to pay the referring party using any of the methods of payment articulated in U.S. patent application Ser. Nos. 13/551,983, 13/552,011, and 13/552,031. The merchant applies the combined discount rate to the product for the referred user 260a.

### Combining Referral Rates: Merchant Embodiment

Merchant B 170 receives from merchant A 160 a referral rate payable to a referring user 110 for referring a specific product or business and stores this referral rate with the merchant A's account 170-160. A merchant B 170 receives the referral rate payable to the referring user 110 offered by the merchant A 160 from merchant A 160 for a specific product. Merchant B 170 stores this referral rate on the referral rates list 160-185. Merchant B 170 adds a referral rate to the amount Merchant A 160 offers. The merchant B 170 combines the two referral rates and stores the combined referral rate additionally on the referral rates list 160-185. Two or more merchants' referral rates may be combined to generate a total collective referral rate. The merchant B 170 displays the collective referral rates to referring users 110 accessing the merchant B's website.

A referring user 110 activates a link with instructions to create a referral hyperlink for the product for the specific referring user. Merchant B 170 creates a referral hyperlink with the combined referral rate as articulated in U.S. patent application Ser. Nos. 13/551,983, 13/552,011, and 13/552,031. Merchant B 170 sends the referral hyperlink to the referring user 110. The referring user 110 posts the referral hyperlink A referred user 120 activates the referral hyperlink posted by the referring user. Merchant B 170 processes the request and demands payment from merchant A 160 and any other merchants which have offered a referral rate for the product (not shown). Merchant B 170 pays the referring user 110 the collective referral rate. In an alternative embodiment, merchant B 170 pays a payment depository 150 as articulated in U.S. patent application Ser. Nos. 13/551,983, 13/552,011, and 13/552,031.

Merchant B 170 receives from merchant A 160 a discount rate payable to a referred user 120 for referring a specific product or business and stores this referral rate with the merchant A's account 170-160. Merchant B 170 receives the discount rate payable to the referred user 120 offered by the merchant A 160 from merchant A 160 for a specific product. Merchant B 170 stores this discount rate on the discounts list 160-180. Merchant B 170 adds a discount to the amount Merchant A 160 offers. Merchant B 170 combines the two discount rates and stores the combined discount rate additionally on the discount rates list 160-180. Two or more merchants' referral rates may be combined to generate a total collective discount rate. Merchant B 170 displays the collective discount rates to referring users 110 accessing the merchant B's website.

A referring user 110 activates a link with instructions to create a referral hyperlink for the product for the specific referring user. Merchant B 170 creates a referral hyperlink with the combined discount rate as articulated in U.S. patent application Ser. Nos. 13/551,983, 13/552,011, and 13/552,031. Merchant B 170 sends the referral hyperlink to the referring user 110. The referring user 110 posts the referral hyperlink A referred user 120 activates the referral hyperlink posted by the referring user. Merchant B 170 processes the request and applies the combined discount rate to the referred users 120 purchase.

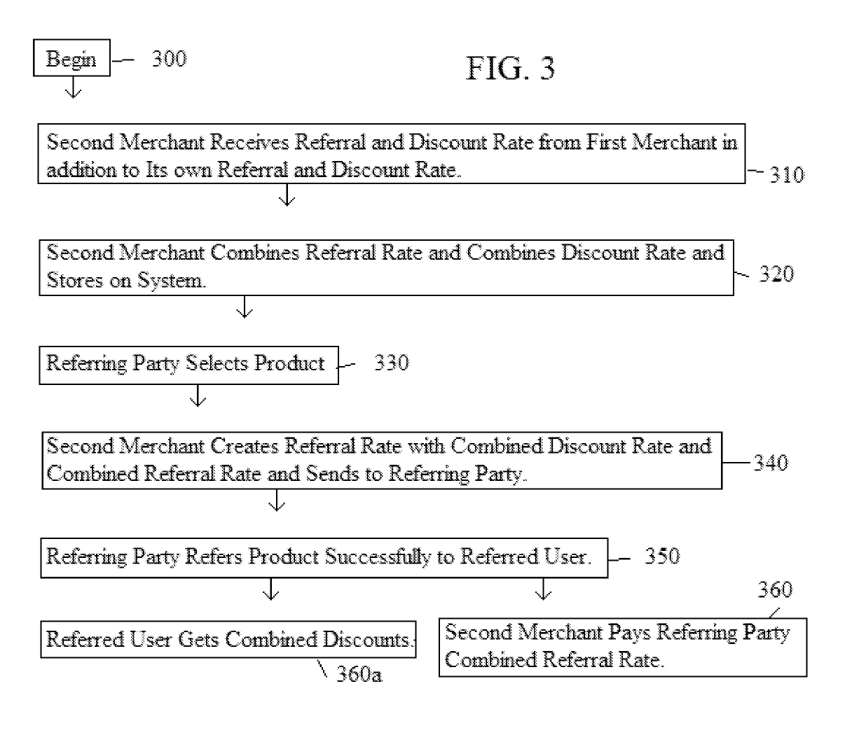

As shown in FIG. 3, the second merchant receives the referral rate and discount rate from the first merchant 310. The second merchant creates an additional discount rate and referral rate 310. The second merchant combines the referral rates and combines the discount rates and stores on the second merchant's system 320. The referring user selects the product which has a combined referral rate and the combined discount rate 330. Using methods articulated in U.S. patent application Ser. Nos. 13/551,983, 13/552,011, and 13/552,031, the second merchant creates a referral hyperlink with the combined referral rates and combined discount rates for the referring party and sends to the referring party 340. The referring party successfully refers the product to the referred user 350. The second merchant pays the referring party the combined referral rate 360 or alternatively, the second merchant instructs the merchants to pay the referring party, or any of the methods of payment articulated in U.S. patent application Ser. Nos. 13/551,983, 13/552,011, and 13/552,031. The second merchant applies the combined discount rate to the product for the referred user 360a.

### Hyperlink Conversion

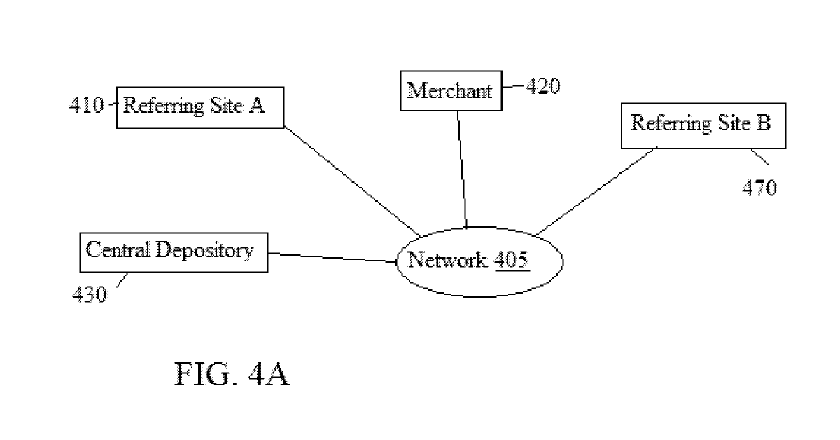

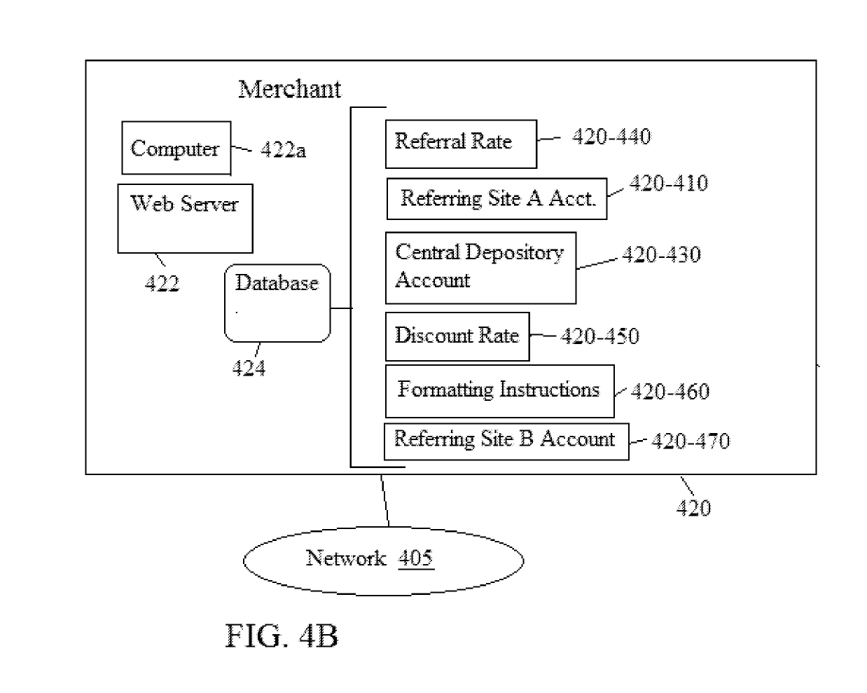

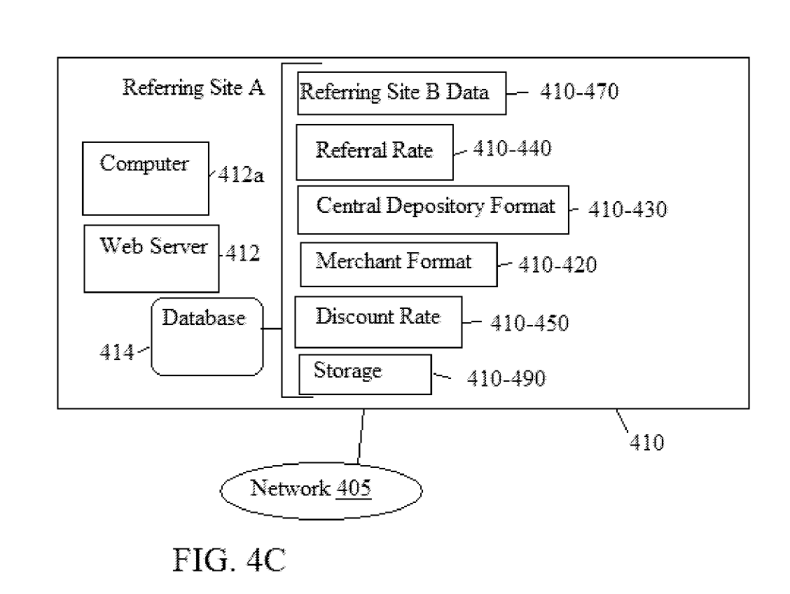

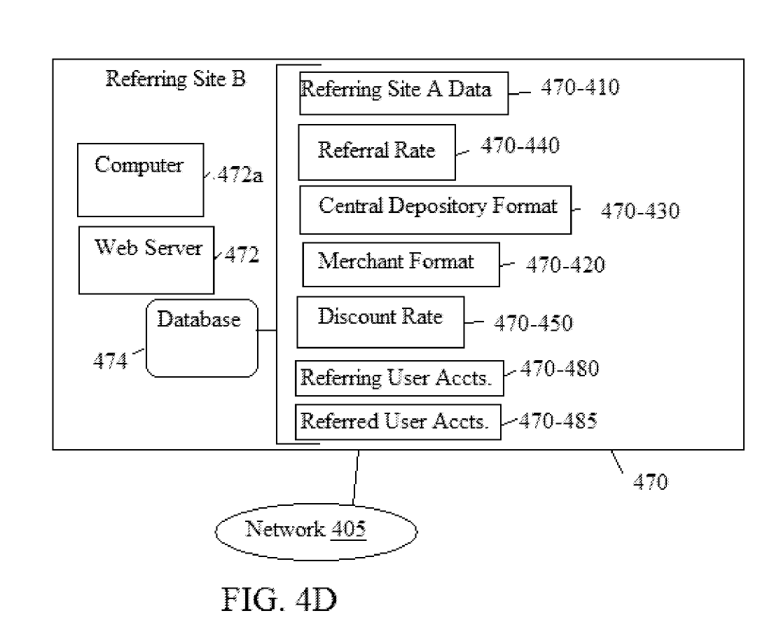

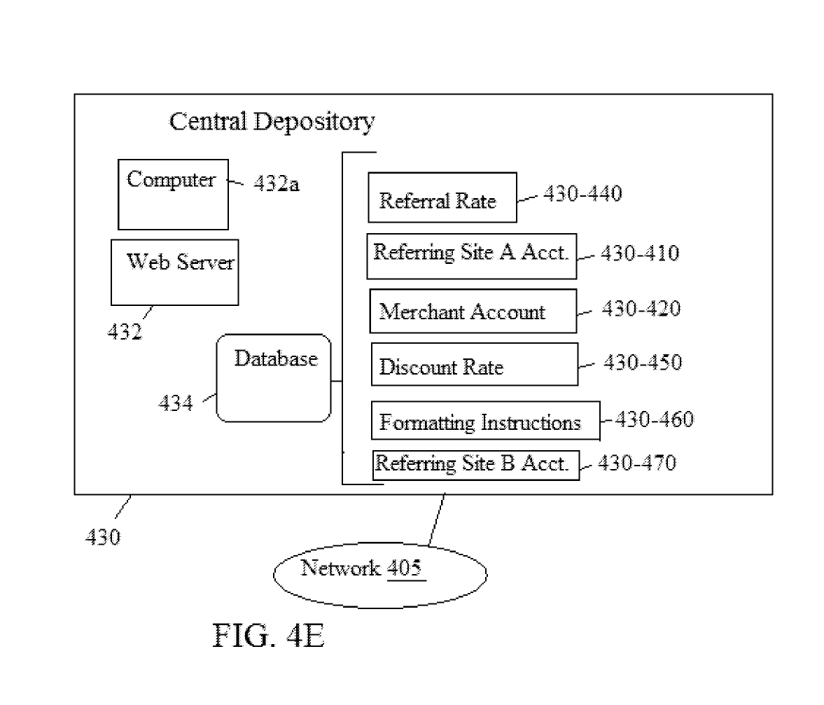

As shown in FIG. 4A the system involved in the hyperlink conversion process comprises: a referring site A system 410, a merchant system 420, a central depository system 430, and a referring site B system 470 connected to a network 405. As shown in FIG. 4B, the merchant system 420 comprises a computer 422a, a web server 422, a database 424 connected to the network 405. The database of the merchant's system 420 comprises: a referral rate list 420-440, a discount rate list 420-450, a referring site A account 420-410, central depository account 420-430, formatting instructions 420-460, a referring site B account 420-470, which contains referring user accounts and associated referral rates that have posted on the referring site B 470. As shown in FIG. 4C, the referring site A system 410 comprises a computer 412a, a web server 412, a database 414 connected to a network 405. The database of the referring site A system 410 comprises: a referral rate list 410-440, a discount rate list 410-450, a merchant format instructions 410-420, central depository format instructions 410-430, advertisement storage 410-490, referring site B data 410-470. As shown in FIG. 4D, the referring site B system 470 comprises a computer 472a, a web server 472, a database 474 connected to the network 405. The database of the referring site system 470 comprises: a referral rate list 470-440, a discount rate list 470-450, a merchant format instructions 470-420, central depository format instructions 470-430, referring user accounts 470-480, referred user account 470-485, and referring site A data 470-410. As shown in FIG. 4E, the central depository system 430 comprises a computer 432a, a web server 432, a database 434 connected to the network 405. The database of the central depository's system 430 comprises: a referral rate list 430-440, a discount rate list 430-450, a referring site A account 430-410, a referring site B account 430-470, which includes accounts for referring users and associated referral rates that have posted on referring site B 470, merchant account 430-420, and formatting instructions 430-460.

A referring site A 410 receives a cookie containing a log in and password information for the referring site B's referred user account 470-485. The referring site A 410 transmits the cookie data to the referring site B 470. Referring site B 470 receives the information and allows for the transmission of referral data to referring site A 410. Referring Site A 410 request information about which users have referred products to the referred user's account 470-485. Referring Site A 410 receives and stores the referral data in Referring Site B data 410-470 on the database 414.

Referring Site A 410 receives a desired promotion associated with a particular search query, product, and merchant. Referring site A 410 stores this desired promotion with the particular search query term and merchant in a database 410-490.

Upon receiving a search query, the referring site A 410 accesses the database to determine the product and merchant associated with the search query term 410-490. Referring Site A 410 then uses the cookie data to access the referring site B referred user account 470-485 to find the referring users 470-480 who have referred products to the referred user.

Referring site A 410 determines if any of the referred products match those products which referring site A associates with the search query, product, or merchant 410-490. Referring site A 410 then parses the hyperlink from the Referring Site B referred user account 470-485 to identify the referred user, product, and merchant. Optionally, Referring site A 410 then adds the referring site A identity to the hyperlink Optionally, referring site A then adds a posting fee to the referral hyperlink Optionally, referring site A then adds a discount to the referral hyperlink

In an optional embodiment, referring site A accesses the referring user account of referring site B 470-480 for referring users associated with the referred user's account 470-485. Referring site A determines other products the referring user has referred in her account 470-480. If the products match those in the search query, the referring site A displays the referrals.

Referring site A 410 then displays the referring user's referral to the referred user after the referred user has entered the search query. The referring user is paid as articulated in U.S. patent application Ser. Nos. 13/551,983, 13/552,011, and 13/552,031. The referring site A 410 is paid from the advertiser for displaying the referral. Optionally, the referring site A 410 is paid a posting fee.

A referring site 410 acquires links to operational web pages belonging to a merchant 420. The referring site creates an account with the merchant 420 and with the central depository 430. The referring site 410 acquires the referral rate 410-440, discount rate 410-450, and format instructions 410-460 belonging to the individual merchant 420 and format instructions belonging to the central depository 410-430. The referring site 410 does this by either manually searching the merchants site 420 and central depository site 430 or through using a crawl program. The referring site 410 stores this information in the referring site database 414. An example of a received hyperlink is as follows:

www.EXAMPLE-MERCHANT.com/lcdtvs1234.html

The referring site 410 then parses the hyperlink to determine the elements of the hyperlink including the item address of the product and the identity of the merchant. The referring site 410 accesses a referring site database 414 connected to the referring site system to receive format instructions for the central depository 410-430. The referring site 410 then creates a new referral hyperlink to the central depository 430 with embedded instructions to route the user to the specific item as follows. Optionally, the referring site adds the referring site identity to the referral hyperlink.

www.EXAMPLE-CENTRAL-DEPOSITORY/cgi-bin/updateandstore.cgi?referring+site=EXAMPLE-REFERRING-SITE&address=www.EXAMPLE-MERCHANT.com/lcdtvs1234.html/

The referring site 410 publishes the referral hyperlink.

In an alternative embodiment, the referring site 410 receives the format instructions for the merchant 410-420. The referring site 410 automatically takes the hyperlink to the merchant pages and alters it to include the referral information including referring site identity so that the merchant can identify which referring site referred the user at the specified referral rate 410-440 and discount rate 410-450. As shown below:

www.EXAMPLE-MERCHANT.com/lcdtvs1234.html/cgi-bin/updateandstore.cgi?referring+site=EXAMPLE-REFERRING-SITE

Further, if the referring site 410 received links from a central depository 430 and desired to link them directly to the merchant 420 the following process is preformed. A referring site 410 acquires referral hyperlinks to an individual merchant 420 from the central depository 430. Referral hyperlinks can be any operational web pages associated with a merchant, which if a referred user activates then a discount is applied to the referred user and the referring site receives a referral fee. In one embodiment, this can be done through the referring site 410 using of a crawl program to search the central depository 430 to find individual pages associated with a merchant 420. An example of a received hyperlink is as follows:

www.EXAMPLE-CENTRAL-DEPOSITORY/cgi-bin/updateandstore.cgi?referring+site=EXAMPLE-REFERRING-SITE&address=www.EXAMPLE-MERCHANT.com/lcdtvs1234.html/

The referring site 410 acquires the referral rate 410-440, discount rate 410-450, format instructions 410-420 belonging to the individual merchant 420, and format instructions 410-430 belonging to the central depository 430. The referring site 410 does this by either manually searching the merchants site 420 or through using a crawl program. The referring site 410 stores this information in the referring site database 414. The referring site 410 then parses the referral hyperlink to determine the elements of the hyperlink including the item address and the identity of the merchant 420. The referring site 410 accesses a referring site database 414 connected to the referring site system to receive format instructions for the particular merchant 410-420. The referring site 410 then creates a new referral hyperlink to the merchant 420. Optionally, the referring site 410 adds the referring site identity to the referral hyperlink An example final hyperlink looks like this.
www.EXAMPLE-MERCHANT.com/lcdtvs1234.html/cgi-bin/updateandstore.cgi?referring+site=EXAMPLE-REFERRING-SITE The referring site 410 publishes the referral hyperlink

In an alternative embodiment, the referring site 410 receives the format instructions for the central depository 410-430. The referring site 410 automatically takes the hyperlink to the central depository pages and alters it to include the referral information including referring site identity so that the central depository can identify which referring site referred the user. As shown below:

www.EXAMPLE-CENTRAL-DEPOSITORY/cgi-bin/updateandstore.cgi?referring+site=EXAMPLE-REFERRING-SITE&address=www.EXAMPLE-MERCHANT.com/lcdtvs1234.html/

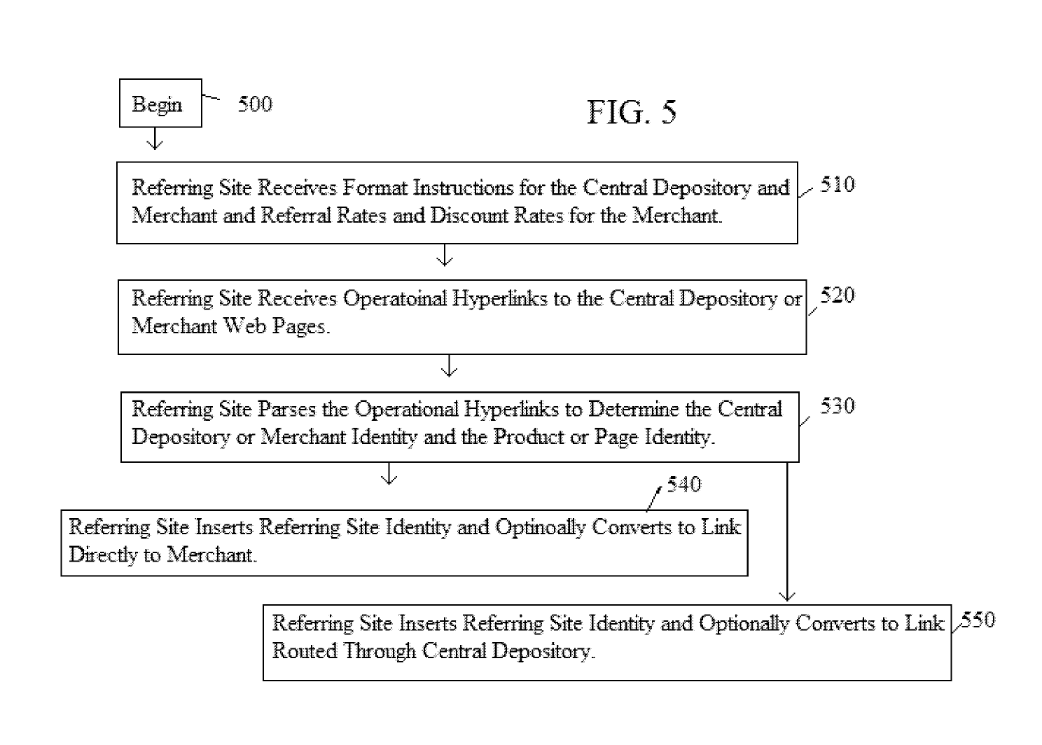

As shown in FIG. 5, the referring site receives the format instructions from the merchant and central depository 510. The referring site also receives the referral rate and discount rate associated with each page or product from the merchant or central depository 510. The referring site receives operational web pages to the merchant or central depository sites 520. The referring site parses the operational links to determine the merchant or central depository identity and optionally the identity of the product or page address 530. The referring site inserts the referring site identity so that the central depository will be able to identify the referring site 540. Optionally, the referring site additionally converts the link from a link to the central depository to a link directly to the merchant 540. The referring site inserts the referring site identity so that the merchant will be able to identify the referring site 550. Optionally, the referring site additionally converts the link from a link directly to the merchant to a link routed through the central depository 550.

### Anonymous Purchasing User

### Merchant Embodiment

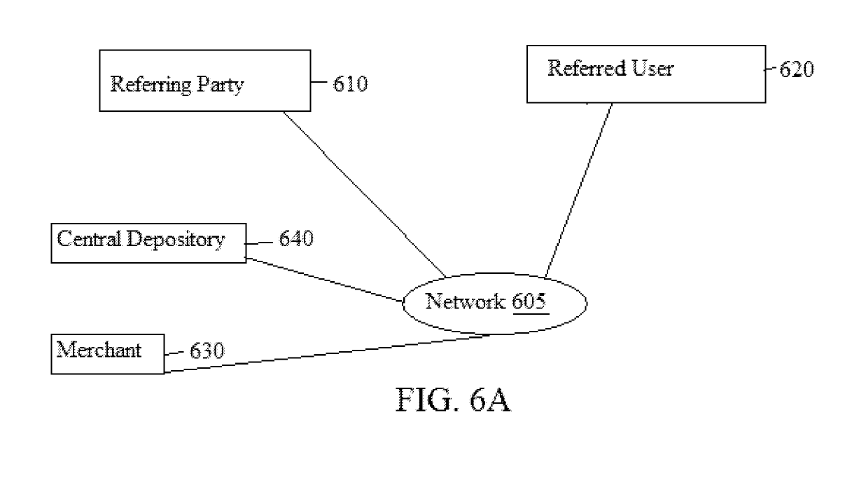

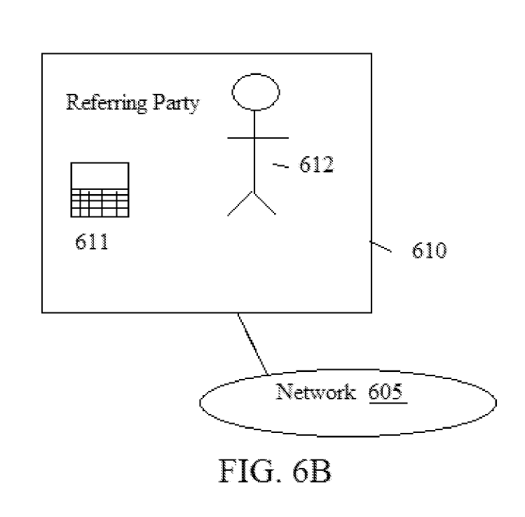

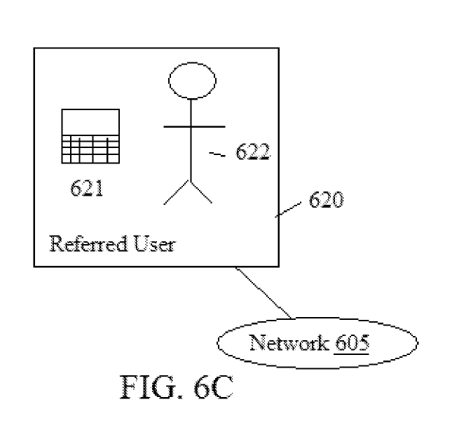

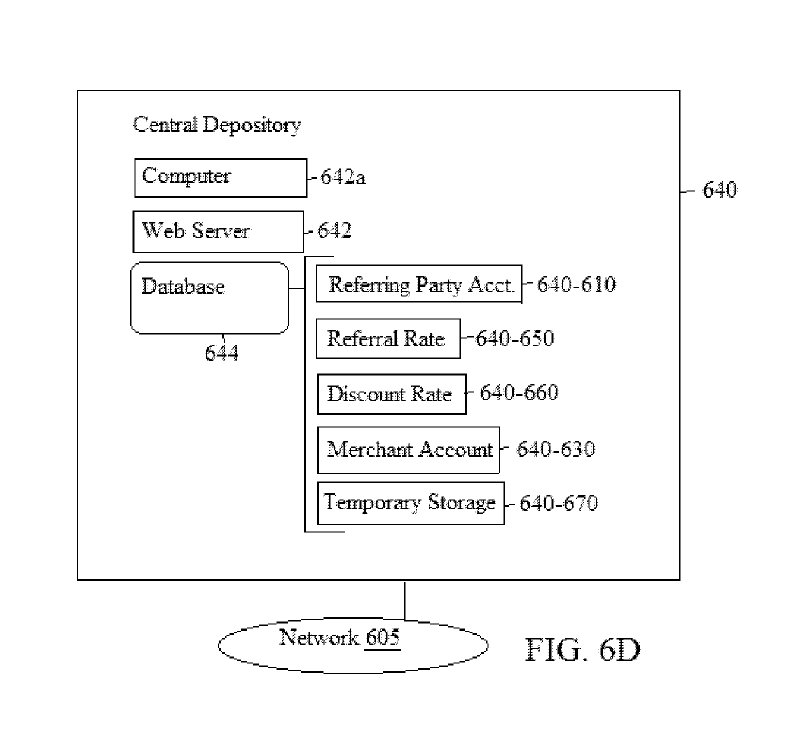

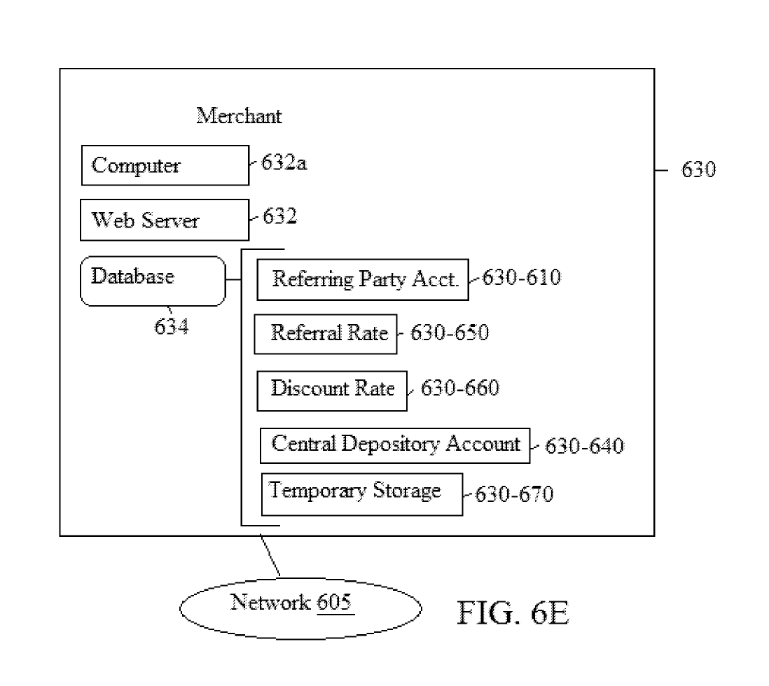

As shown in FIG. 6A, a system involving an anonymous purchasing user comprises: a referring party 610, a referred user 620, a merchant system 630, and a central depository system 640 and network 605. As shown in FIG. 6B, a referring party 610 consists of a referring website or individual 612 with a computer 611 connected to the network 605. As shown in FIG. 6C, a referred user 620 consists of a individual 622 with a computer 621 connected to the network 605. As shown in FIG. 6D, a central depository system 640 consists of a computer 642a, a web server 642, a database 644 connected to the network 605. The database compromises a referring party account 640-610, a referral rate list 640-650, a discount list 640-660, a merchant account 640-630, and a temporary storage unit for storing referred user i.p addresses 640-670. As shown in FIG. 6E, a merchant system 630 consists of a computer 632a, a web server 632, a database 634 connected to the network 605. The merchant database 634 consists of a referring party account 630-610, a referral rate list 630-650, a discount list 630-660, a central depository account 630-640, and a temporary storage unit for storing referred user i.p. addresses 630-670. The referral list is a list of all the referral rates for each party is paid for referring products. The discount list is a list of all discount rates for all users applied when purchasing the product.

A referring party 610 displays a referral hyperlink to a referred user 620 linked directly to a merchant 630. Upon activation by a referred user 620, the merchant 630 then processes the discount without having a referred user create account. This can be accomplished in several ways.

First, the merchant 630 identifies the referring party 610 either through the HTTP_REFERER command or through a referring party identity contained in the referral hyperlink If the HTTP_REFERER data is used the merchant associates the referring party account 630-610 with the URL received from the HTTP_REFERER data. In one embodiment, the merchant parses the referral hyperlink to determine the referring party identity.

The merchant 630 then searches the referring party's account 630-610 to determine the discount 630-660 to apply to the referred user. The merchant 630 also searches the referring party's account 630-610 to determine the referral rate 630-650 to pay to the referring party 610. The merchant 630 receives the referred user's i.p. address from the referred user's browser. The merchant 630 creates a temporary account for the internet protocol address and stores the entitled discount with the ip address 630-670. If the referred user 620 from the ip address makes a purchase within some time period the merchant applies the discount to the purchase from the ip address which activated the link The time period may be a set time that the discount is good for, or the end of the browsing session.

Second, the merchant 630 can include a discount identifier in the referral hyperlink sent to the referring party 610 indicating the discount amount the referred user is entitled to by activating the referral hyperlink A referral hyperlink with a discount identifier resembles the following:

http://www.EXAMPLE-MERCHANT.com/lcdtv1234.html/cgi-bin/updateandstore.cgi?discount=.1

The referring party 610 posts the hyperlink and the referred user 620 activates the referral hyperlink The merchant 630 parses the hyperlink The merchant 630 receives the referred user's ip address from the referred user's browser. The merchant 630 creates a temporary account for the ip address and stores the discount with the ip address on the temporary storage unit 630-670. If the referred user 620 from the ip address makes a purchase within some time period the merchant applies the discount to the purchase from the ip address which activated the link The time period may be a set time that the discount is good for, or the end of the browsing session.

### Central Depository Embodiment:

A referring party 610 displays a referral hyperlink to a referred user 620 linked to a central depository 640. Upon activation by a referred user 620, the central depository 640 then transfers the discount to the merchant 630 without a referred user account created by the referred user. The central depository also credits the referring party 610 the referral fee owed. In an optional embodiment the central depository 640 stores the discount associated with i.p. address 640-670. This can be accomplished in several ways.

First, the merchant 630 uploads the discount amount the referring party 610 is entitled to give in discounts to referred users to the central depository 640. The central depository stores this data in a database 640-660. The central depository 640 identifies the referring party 610 either through the HTTP_REFERER data or through a referring party identity contained in the referral hyperlink If the HTTP_REFERER data is used the central depository associates the referring party account 640-610 with the data received from the HTTP_REFERER data. In one embodiment, the central depository then parses the referral hyperlink to determine the referring party identity 610.

The central depository 640 then searches the referring party's account 640-610 to determine the discount to apply to the referred user 620. The central depository 640 receives the referred user's ip address from the referred user's browser. The central depository 640 sends the merchant 630 the identity of the discount associated with the ip address. This may be accomplished through routing the referred user to a merchant webpage with a query string containing the discount or sending a direct electronic communication. Optionally, the central depository 640 sends the merchant 630 the referred user's ip address. If the central depository 640 does not send the ip address, the merchant 630 receives the ip address of the referred user 620 from the referred user's browser. The merchant creates a temporary account for the ip address 630-670 and stores the entitled discount with the ip address. If the referred user 620 from the ip address makes a purchase within some time period the merchant 630 applies the discount to the purchase from the ip address which activated the link The time period may be a set time that the discount is good for, or the end of the browsing session.

Optionally, the central depository 640 sends the referring party 610 identity to the merchant 630. The merchant 630 accesses the merchants database system 634 containing referring party identities 630-610, referral rates 630-650, and discounts 630-660, referring parties are entitled to give, to determine the discount the referring party 610 is entitled to give the referred user 620. This may be accomplished through routing the referred user 620 to a merchant webpage 630 with a query string containing the referring party's identity or sending other forms of direct electronic communication. Optionally, the central depository 640 sends the merchant 630 the referred user's ip address. If the central depository 640 does not send the referred user's ip address, the merchant 630 receives the ip address of the referred user from the referred user's browser. The merchant 630 accesses a database on the merchant's system to determine the discount amount the referring party 610 is entitled to give the referred user. The merchant 630 creates a temporary account for the ip address and stores the entitled discount with the ip address on the database 630-670. If the referred user 620 from the ip address makes a purchase within some time period the merchant 630 applies the discount to the purchase from the ip address which activated the link The time period may be a set time that the discount is good for, or the end of the browsing session.

Second, the central depository 640 can include a discount identifier in the hyperlink sent to the referring party 610 indicating the discount amount the referred user 620 is entitled to by activating the referral hyperlink A referral hyperlink with a discount identifier resembles the following:

http://www.EXAMPLE-CENTRAL-DEPOSITORY.com/cgi-bin/updateandstore.cgi?discount=.1&url=EXAMPLE-MERCHANT.com/lcdtv1234.html

Optionally, the referral hyperlink can contain the identity of the referring party 610 and not the discount amount. In this embodiment, the discount amount is determined either by the merchant 630 or central depository 640 searching the discount amount the referring party 610 is entitled to give referred users 620 and applying that amount to a temporary account associated with an ip address of the referred user 640-670.

The referring party 610 sends the referral hyperlink to the referred user 620. The referred user 620 activates the referral hyperlink The central depository 640 parses the referral hyperlink The central depository 640 receives the referred user's ip address from the referred user's browser. The central depository 640 sends the merchant 630 the identity of the discount associated with the ip address. This may be accomplished through routing the referred user 620 to a merchant webpage 630 with a query string containing the discount or sending a direct electronic communication. An example of the query string approach is as follows:

http://www.EXAMPLE-MERCHANT.com/lcdtv1234.html/cgi-bin/updateandstore.cgi?discount=.1

Optionally, the central depository 640 sends the referred user's ip address. If the central depository 640 does not send the ip address, the merchant 630 receives the ip address of the referred user 620 from the referred user's browser. The merchant 630 creates a temporary account for the ip address and stores the entitled discount with the ip address 630-670. If the referred user 620 from the ip address makes a purchase within some time period the merchant 630 applies the discount to the purchase from the ip address which activated the referral hyperlink The time period may be a set time that the discount is good for, or the end of the browsing session. In all these embodiments the referring user is paid for making the referral.

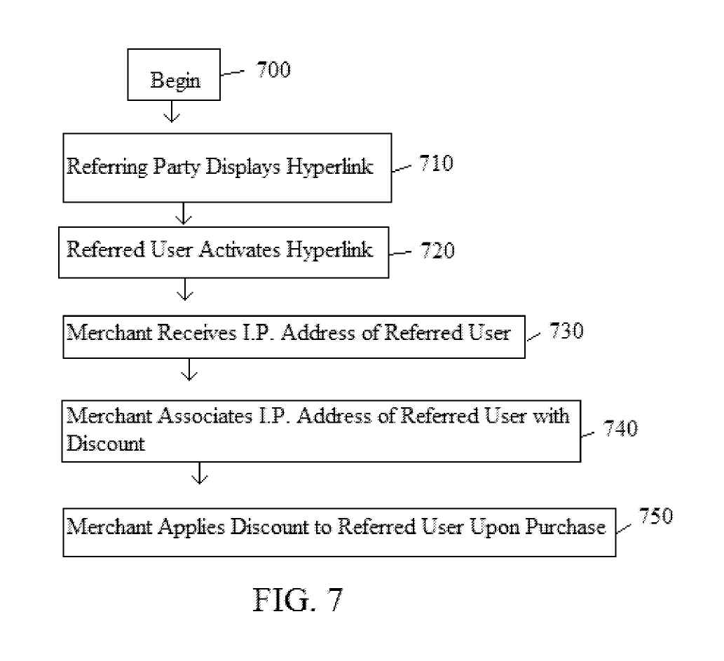

As shown in FIG. 7, a referring party displays a referral hyperlink to a referred user 710. The referred user activates the referral hyperlink 720. The merchant receives the I.P. address of the referred user from the referred users browser 730. The merchant stores the referred user I.P. address and associates the referred user's ip address with a discount based on the discount the referring user was entitled to give 740. The merchant applies the discount to the purchase when the referred user makes a purchase 750.

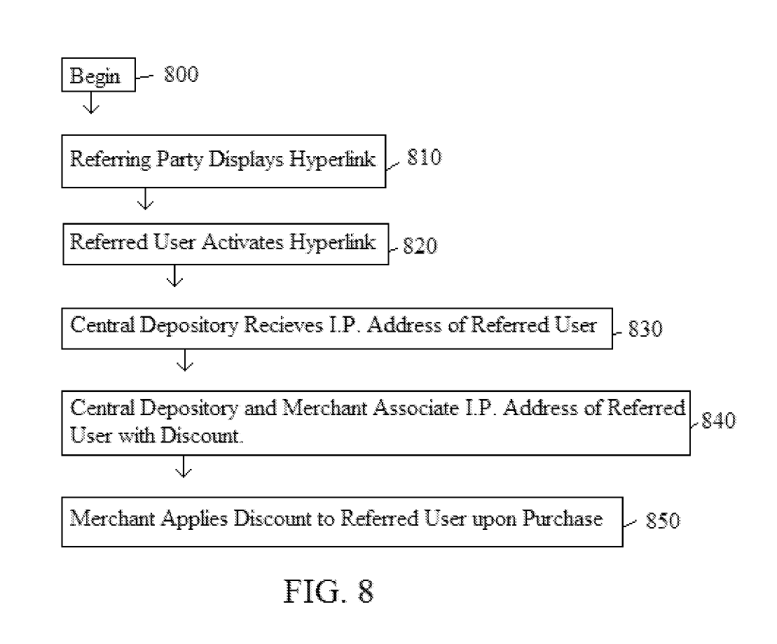

As shown in FIG. 8, a referring party displays a referral hyperlink to a referred user 810. The referred user activates the referral hyperlink 820. The central depository receives the I.P. address of the referred user from the referred user's browser and the associated referring party from the referral hyperlink 830. The central depository associates the I.P. address of the referred user with the discount the referring party was entitled to give 840. The central depository credits the referring user with the referral. The central depository sends the merchant the identity of the referring party and optionally, the discount associated with referred user's I.P. address. The merchant associates the I.P. address of the referred user with the discount 840. The merchant applies the discount to the purchase when the referred user makes a purchase 850.

The computer architecture for implementing all embodiments of every section including the combining referral rates, hyperlink conversion, and the anonymous referring user is described in U.S. patent application Ser. Nos. 13/551,983, 13/552,011, and 13/552,031 of which this patent is a continuation-in-part.

While examples of various embodiments have been described, it is to be understood that the embodiments described are illustrative only and that the scope of the invention is to be define solely by the appended claims when accorded a full range of equivalence, many variations and modifications naturally occurring to those of skill in the art from a perusal hereof.

What is claimed is:

1. A computer implemented method for electronic referral preformed at a computer of a central depository, the method comprising:
receiving from a first merchant a referral rate for a first product;
receiving from at least one second merchant at second referral rate for a first product;
combining the first referral rate and second referral rate to yield a third referral rate for a first product;
storing the third referral rate;
receiving a first message from a referring party indicating that the referring party desires to refer a first product from a second merchant;
creating a referring party account for the referring party;
creating a referral hyperlink configured to route a referred user, upon activation of the hyperlink, to one of the central depository, where in the referral hyperlink includes first data identifying the first product, and second merchant identity.

2. The method of claim 1, further comprising including with the first data the identity of the referring user.

3. The method of claim 1, further comprising including with the first data the identity of the combined referral rate.

4. The method of claim 1, further comprising sending the hyperlink to the referring party.

5. The method of claim 1, wherein the referring party is one of a referring site and an administrator of the referring site.

6. The method of claim 1, where in the referring party is a referring user.

7. The method of claim 1, further comprising:
receiving a message from a referred user upon activation of the referral hyperlink by the referred user;
automatically parsing the second message to identify the first data;
updating the referring party account to reflect activation of the referral hyperlink;
sending the merchant information related to referral of the selected item; and
routing the referred user to a website displaying the selected item.

8. The method of claim 1, further comprising:
sending a first message to the first merchant wherein the first message includes a request for payment from the merchant for the referral of the selected item;
sending a second message to the second merchant wherein the second message includes a request for payment from the merchant for the referral of the selected item;

9. The method of claim 8, further comprising:
receiving payment from the first merchant wherein the payment is at least in part for the referral of the first product;
receiving payment from the second merchant where in the payment is at least in part for the referral of the first product

10. The method of claim 9, further comprising paying the referring party at least in part for referral of the first product.

11. A computer implemented method for electronic referral preformed at a computer of a second merchant, the method comprising:
receiving from at least one first merchant a referral rate for a first product;
adding a second referral rate for a first product;
combining the first referral rate and second referral rate to yield a third referral rate for a first product;
storing the third referral rate;
receiving a first message from a referring party indicating that the referring party desires to refer a first product from the second merchant;
creating a referring party account for the referring party;
creating a referral hyperlink configured to route a referred user, upon activation of the hyperlink, to one of a central depository and the second merchant, where in the referral hyperlink includes first data identifying the first product, and second merchant identity.

12. The method of claim 11, further comprising including with the first data the identity of the referring user.

13. The method of claim 11, further comprising including with the first data the identity of the combined referral rate.

14. The method of claim 11, further comprising sending the hyperlink to the referring party.

15. The method of claim 11, wherein the referring party is one of a referring site and an administrator of the referring site.

16. The method of claim 11, wherein the referring party is a referring user.

17. The method of claim 11, further comprising sending a first message to the first merchant wherein the first message includes a request for payment from the first merchant for the referral of the selected item.

18. The method of claim 17, further comprising receiving payment from the first merchant wherein the payment is at least in part for the referral of the first product;

19. The method of claim 18, further comprising paying the referring party at least in part for referral of the first product.

20. A computer implemented method for electronic referral preformed at a computer of a central depository, the method comprising:
receiving from a first merchant a referral rate for a first product;
receiving from at least one second merchant at second referral rate for a first product;
combining the first referral rate and second referral rate to yield a third referral rate for a first product;
Storing the third referral rate;
receiving a first message from a referring party indicating that the referring party desires to refer a first product from a second merchant;
creating a referring party account for the referring party;
creating a referral hyperlink configured to route a referred user, upon activation of the hyperlink, to one of the second merchant, where in the referral hyperlink includes first data identifying the first product, second data identifying at least one of the second merchant, and the referring user, and third data identifying the third referral rate.
